(19) United States
(12) Patent Application Publication
(10) Pub. No.: US 2003/0088654 A1
(43) Pub. Date: May 8, 2003

(54) Directory server schema replication

(76) Inventors: Gordon Good, Mountainview, CA (US); Mark C. Smith, Saline, MI (US)

Correspondence Address: ROSENTHAL & OSHA L.L.P., 1221 MCKINNEY AVENUE, SUITE 2800, HOUSTON, TX, 77010, US

(21) Appl. No.: 10/003,040

(22) Filed: Nov. 2, 2001

(51) Int. Cl. G06F 15/173

(52) U.S. Cl. 709/223

(57) ABSTRACT

A method of schema replication in a directory server including updating a schema at a replication supplier, computing a change sequence number, placing the change sequence number in an attribute on the replication supplier, initiating a replication session to a replication consumer, reading the change sequence number on the replication consumer, updating the schema on the replication consumer if the change sequence number on the replication consumer is less than the change sequence number on the replication supplier, and propagating a schema update from the replication supplier to each replication consumer.

### BACKGROUND OF INVENTION

The most fundamental program resident on any computer is the operating system (OS). Various operating systems exist in the market place, including Solaris™ from Sun Microsystems Inc., Palo Alto, Calif. (Sun Microsystems), MacOS from Apple Computer, Inc., Cupertino, Calif., Windows® 95/98 and Windows NT®, from Microsoft Corporation, Redmond, Wash., UNIX, and Linux. The combination of an OS and its underlying hardware is referred to herein as a “traditional platform.” Prior to the popularity of the Internet, software developers wrote programs specifically designed for individual traditional platforms with a single set of system calls and, later, application program interfaces (APIs). Thus, a program written for one platform could not be run on another. However, the advent of the Internet made cross-platform compatibility a necessity and a broader definition of a platform has emerged. Today, the original definition of a traditional platform (OS/hardware) dwells at the lower layers of what is commonly termed a “stack,” referring to the successive layers of software required to operate in the environment presented by the Internet and World Wide Web.

Effective programming at the application level requires the platform concept to be extended all the way up the stack, including all the new elements introduced by the Internet. Such an extension allows application programmers to operate in a stable, consistent environment.

iPlanet™ E-commerce Solutions, a Sun Microsystems|Netscape Alliance, has developed a net-enabling platform shown in FIG. 1 called the Internet Service Deployment Platform (ISDP) (28). ISDP (28) gives businesses a very broad, evolving, and standards-based foundation upon which to build an e-enabled solution.

A core component of the ISDP (28) is iPlanet™ Directory Server (80), a Lightweight Directory Access Protocol (LDAP)-based solution that can handle more than 5,000 queries per second. iPlanet™ Directory Server (iDS) provides a centralized directory service for an intranet or extranet while integrating with existing systems. The term “directory service” refers to a collection of software, hardware, and processes that store information and make the information available to users. The directory service generally includes at least one instance of the iDS and one or more directory client program(s). Client programs can access names, phone numbers, addresses, and other data stored in the directory.

The iDS is a general-purpose directory that stores all information in a single, network-accessible repository. The iDS provides a standard protocol and application programming interface (API) to access the information contained by the iDS. The iDS provides global directory services, meaning that information is provided to a wide variety of applications. Until recently, many applications came bundled with a proprietary database. While a proprietary database can be convenient if only one application is used, multiple databases become an administrative burden if the databases manage the same information. For example, in a network that supports three different proprietary e-mail systems where each system has a proprietary directory service, if a user changes passwords in one directory, the changes are not automatically replicated in the other directories. Managing multiple instances of the same information results in increased hardware and personnel costs.

The global directory service provides a single, centralized repository of directory information that any application can access. However, giving a wide variety of applications access to the directory requires a network-based means of communicating between the numerous applications and the single directory. The iDS uses LDAP to give applications access to the global directory service.

LDAP is the Internet standard for directory lookups, just as the Simple Mail Transfer Protocol (SMTP) is the Internet standard for delivering e-mail and the Hypertext Transfer Protocol (HTTP) is the Internet standard for delivering documents. Technically, LDAP is defined as an on-the-wire bit protocol (similar to HTTP) that runs over Transmission Control Protocol/Internet Protocol (TCP/IP). LDAP creates a standard way for applications to request and manage directory information.

An LDAP-compliant directory, such as the iDS, leverages a single, master directory that owns all user, group, and access control information. The directory is hierarchical, not relational, and is optimized for reading, reliability, and scalability. This directory becomes the specialized, central repository that contains information about objects and provides user, group, and access control information to all applications on the network. For example, the directory can be used to provide information technology managers with a list of all the hardware and software assets in a widely spanning enterprise. Most importantly, a directory server provides resources that all applications can use, and aids in the integration of these applications that have previously functioned as stand-alone systems. Instead of creating an account for each user in each system the user needs to access, a single directory entry is created for the user in the LDAP directory. FIG. 2 shows a portion of a typical directory with different entries corresponding to real-world objects. The directory depicts an organization entry (90) with the attribute type of domain component (dc), an organizational unit entry (92) with the attribute type of organizational unit (ou), a server application entry (94) with the attribute type of common name (cn), and a person entry (96) with the attribute type of user ID (uid). All entries are connected by the directory.

Understanding how LDAP works starts with a discussion of an LDAP protocol. The LDAP protocol is a message-oriented protocol. The client constructs an LDAP message containing a request and sends the message to the server. The server processes the request and sends a result, or results, back to the client as a series of LDAP messages. Referring to FIG. 3, when an LDAP client (100) searches the directory for a specific entry, the client (100) constructs an LDAP search request message and sends the message to the LDAP server (102) (step 104). The LDAP server (102) retrieves the entry from the database and sends the entry to the client (100) in an LDAP message (step 106). A result code is also returned to the client (100) in a separate LDAP message (step 108).

LDAP-compliant directory servers like the iDS have nine basic protocol operations, which can be divided into three categories. The first category is interrogation operations, which include search and compare operators. These interrogation operations allow questions to be asked of the directory. The LDAP search operation is used to search the directory for entries and retrieve individual directory entries. No separate LDAP read operation exists. The second category is update operations, which include add, delete, modify, and modify distinguished name (DN), i.e., rename, operators. A DN is a unique, unambiguous name of an entry in LDAP. These update operations allow the update of information in the directory. The third category is authentication and control operations, which include bind, unbind, and abandon operators.

The bind operator allows a client to identify itself to the directory by providing an identity and authentication credentials. The DN and a set of credentials are sent by the client to the directory. The server checks whether the credentials are correct for the given DN and, if the credentials are correct, notes that the client is authenticated as long as the connection remains open or until the client re-authenticates. The unbind operation allows a client to terminate a session. When the client issues an unbind operation, the server discards any authentication information associated with the client connection, terminates any outstanding LDAP operations, and disconnects from the client, thus closing the TCP connection. The abandon operation allows a client to indicate that the result of an operation previously submitted is no longer of interest. Upon receiving an abandon request, the server terminates processing of the operation that corresponds to the message ID.

In addition to the three main groups of operations, the LDAP protocol defines a framework for adding new operations to the protocol via LDAP extended operations. Extended operations allow the protocol to be extended in an orderly manner to meet new marketplace needs as they emerge.

The basic unit of information in the LDAP directory is an entry, a collection of information about an object. Entries are composed of a set of attributes, each of which describes one particular trait of an object. Attributes are composed of an attribute type (e.g., common name (cn), surname (sn), etc.) and one or more values. FIG. 4 shows an exemplary entry (124) showing attribute types (120) and values (122). Attributes may have constraints that limit the type and length of data placed in attribute values (122). A directory schema places restrictions on the attribute types (120) that must be, or are allowed to be, contained in the entry (124).

### SUMMARY OF INVENTION

In general, in one aspect the invention relates to a method of schema replication in a directory server. The method comprises updating a schema at a replication supplier, computing a change sequence number, placing the change sequence number in an attribute on the replication supplier, initiating a replication session to a replication consumer, reading the change sequence number on the replication consumer, updating the schema on the replication consumer if the change sequence number on the replication consumer is less than the change sequence number on the replication supplier, and propagating a schema update from the replication supplier to each replication consumer.

In general, in one aspect the invention relates to a method of schema replication in a directory server. The method comprises updating a schema at a replication supplier, computing a change sequence number, placing the change sequence number in an attribute on the replication supplier, initiating a replication session to a replication consumer, reading the change sequence number on the replication consumer, updating the schema on the replication consumer if the change sequence number on the replication consumer is less than the change sequence number on the replication supplier, propagating a schema update from the replication supplier to each replication consumer, replacing contents of a schema entry on each replication consumer with contents of a schema entry on the replication supplier, maintaining the schema on a master supplier server, copying the schema to plurality of servers after updating the master supplier, holding the change sequence number on the replication consumer in an attribute, querying the schema with standard Lightweight Directory Application Protocol operations, and modifying the schema with standard Lightweight Directory Application Protocol operations.

In general, in one aspect the invention relates to a method of defining a schema in a directory server. The method comprises identifying an object class in the schema, placing the object class on an entry, storing a data element in an attributed in the directory server used by the schema, extending the schema with a new object class and a new attribute, describing a document with a private field comprising a description of the object class and the attribute, and representing the data element as an attribute-data pair.

In general, in one aspect the invention relates to a method of defining a schema in a directory server. The method comprises identifying an object class in the schema, placing the object class on an entry, storing a data element in an attribute in the directory server used by the schema, extending the schema with a new object class and a new attribute, describing a document with a private field comprising a description of the object class and the attribute, representing the data element as an attribute-data pair, defining the object class in the directory server, storing the object class in the directory server, and maintaining the integrity of the data element stored in the directory server is by imposing constraints on data values.

In general, in one aspect the invention relates to a computer system for schema replication a directory server. The computer system comprises a processor, a memory, and software instructions stored in the memory for enabling the computer system under control of the processor. The software instructions perform updating a schema at a replication supplier, computing a change sequence number, placing the change sequence number in an attribute on the replication supplier, initiating a replication session to a replication consumer, reading the change sequence number on the replication consumer, updating the schema on the replication consumer if the change sequence number on the replication consumer is less than the change sequence number on the replication supplier, and propagating a schema update from the replication supplier to each replication consumer.

In general, in one aspect the invention relates to an apparatus replicating a schema in a directory server. The apparatus comprises means for updating a schema at a replication supplier, means for computing a change sequence number, means for placing the change sequence number in an attribute on the replication supplier, means for initiating a replication session to a replication consumer, means for reading the change sequence number on the replication consumer, means for updating the schema on the replication consumer if the change sequence number on the replication consumer is less than the change sequence number on the replication supplier, and means for propagating a schema update from the replication supplier to each replication consumer.

In general, in one aspect the invention relates to an apparatus defining a schema in a directory server. The apparatus comprises means for identifying an object class in the schema, means for placing the object class on an entry, means for storing a data element in an attribute in the directory server used by the schema, means for extending the schema with a new object class and a new attribute, means for describing a document with a private field comprising a description of the object class and the attribute, and means for representing the data element as an attribute-data pair.

Other aspects and advantages of the invention will be apparent from the following description and the appended claims.

### BRIEF DESCRIPTION OF DRAWINGS

FIG. 1 illustrates a block diagram of iPlanet™ Internet Service Development Platform.

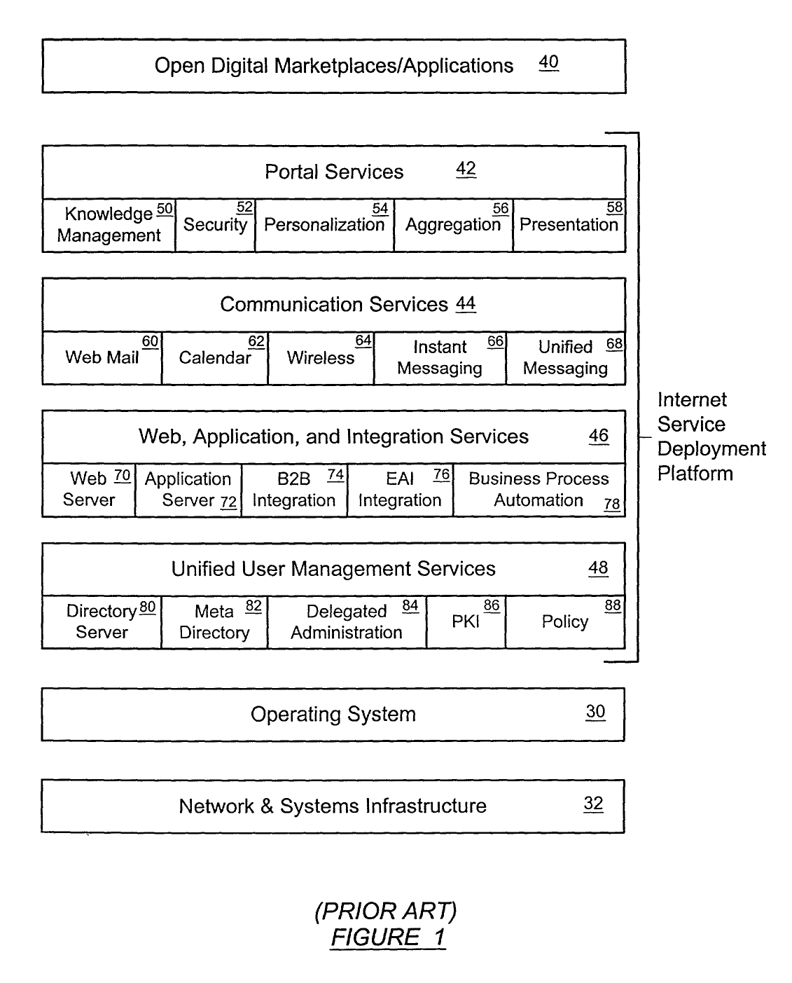

FIG. 2 illustrates part of a typical directory.

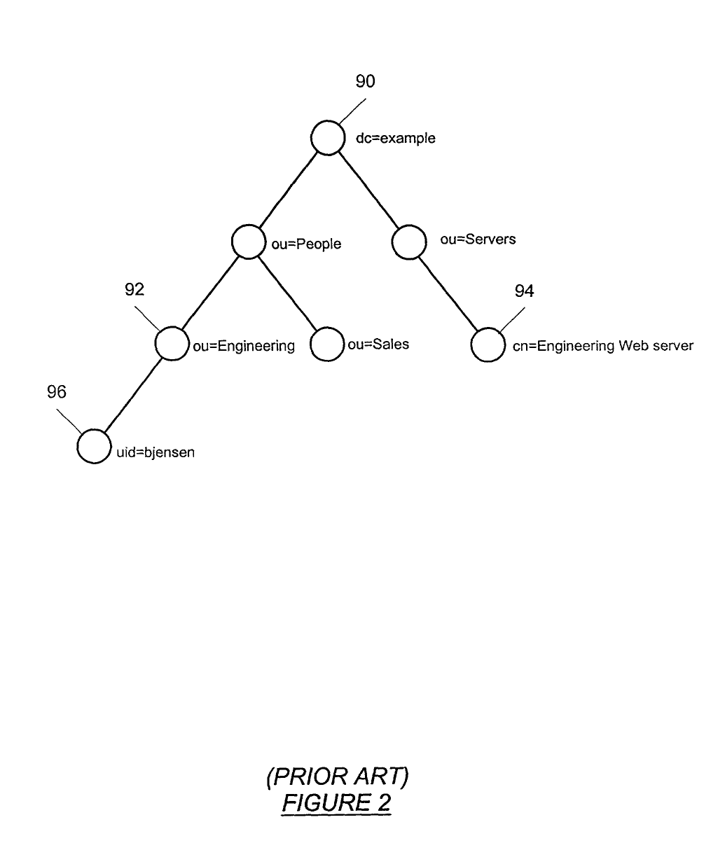

FIG. 3 illustrates the LDAP protocol used for a simple request.

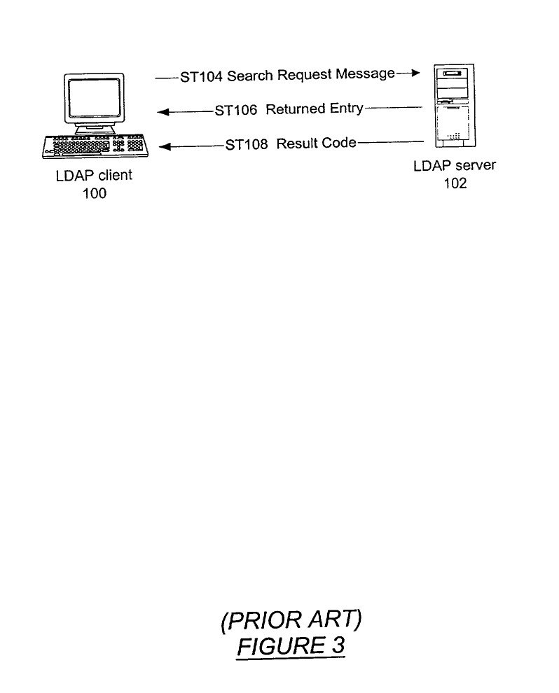

FIG. 4 illustrates a directory entry showing attribute types and values.

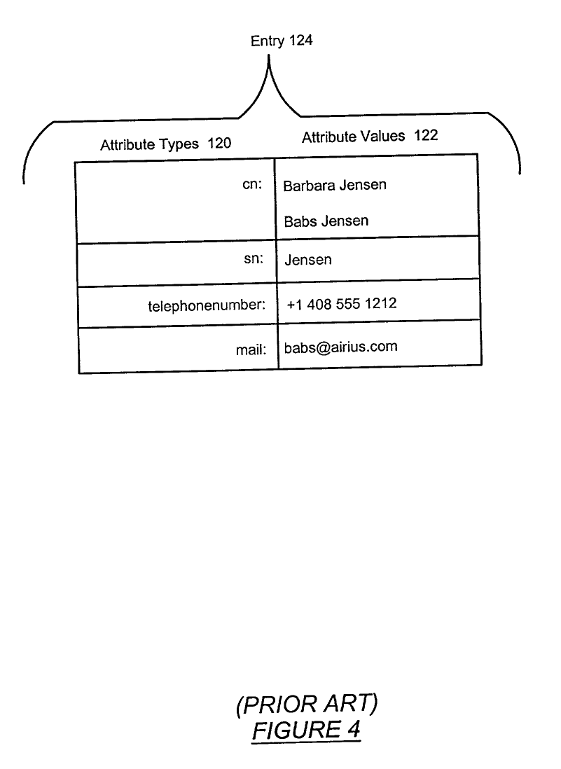

FIG. 5 illustrates a typical computer with components.

FIG. 6 illustrates a flow process of a schema replication in accordance with one or more embodiments of the present invention.

### DETAILED DESCRIPTION

Specific embodiments of the invention will now be described in detail with reference to the accompanying figures. Like elements in the various figures are denoted by like reference numerals for consistency.

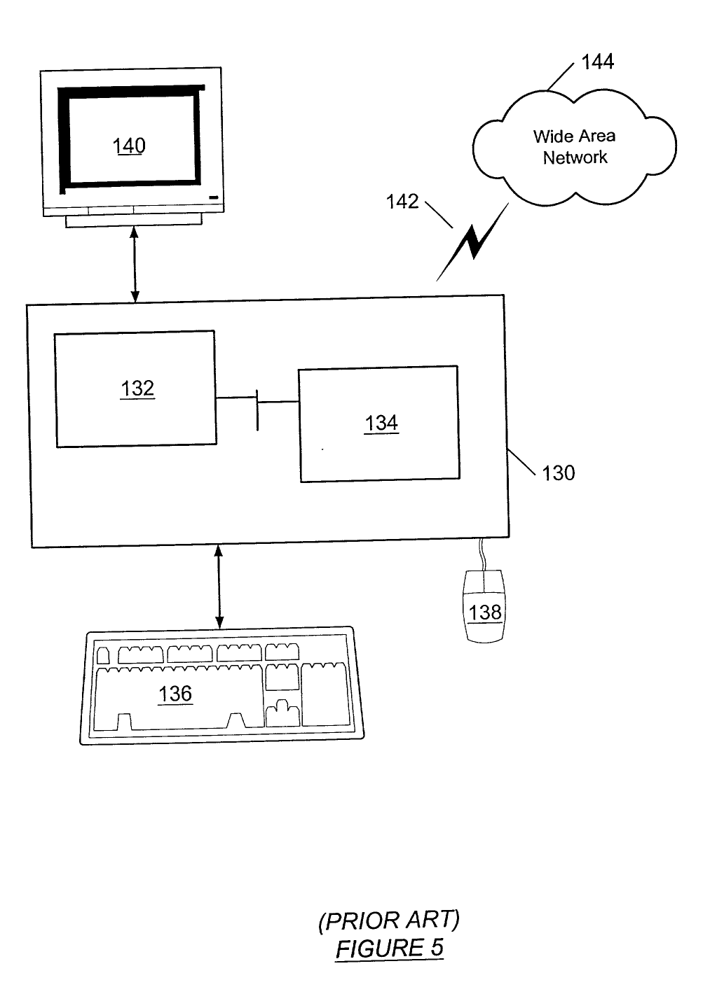

The invention described here may be implemented on virtually any type computer regardless of the traditional platform being used. For example, as shown in FIG. 5, a typical computer (130) has a processor (132), memory (134), among others. The computer (130) has associated therewith input means such as a keyboard (136) and a mouse (138), although in an accessible environment these input means may take other forms. The computer (130) is also associated with an output device such as a display (140), which also may take a different form in a given accessible environment. The computer (130) is connected via a connection means (142) to a wide area network (144), such as the Internet.

The present invention involves schema replication in a directory server. A directory schema maintains the integrity of the data stored in a directory server by imposing constraints on such items as the size, range, and format, etc. of data values. The types of entries of the directory are customizable and may include people, devices, organizations, etc. The attributes available to each entry is also customizable.

A pre-defined schema is typically included with the directory server includes both a standard LDAP schema as well as additional application-specific schema to support the features of the directory server. While the pre-defined schema meets most directory needs, the schema may be extended with new object classes and attributes to accommodate the unique needs of a particular directory.

The format, standard attributes, and object classes included in the standard schema is described below. The directory server bases the schema format on version 3 of the LDAP protocol as described in RFC 2252. For more detailed information about the LDAPv3 schema format, refer to the LDAPv3 Attribute Syntax Definitions document (RFC2252). This protocol requires directory servers to publish schemas through LDAP itself, allowing directory client applications to programmatically retrieve the schema and adapt behavior based on the schema. The global set of schema for the directory server may be found in an entry named cn=schema.

In one or more embodiments, the directory server standard schema varies from LDAPv3 schema, as the schema uses proprietary attributes and object classes. The attributes and object classes are discussed in greater detail below. In addition, the directory server uses a private field in the schema entries called X-ORIGIN, which describes the document where the human readable description of the attribute or object may be found. For example, a standard person object class appears in the schema as follows: objectclasses: (2.5.6.6 NAME ‘person’ DESC ‘Standard Person Object Class’ SUP top MUST (objectlass $ sn $ cn) MAY (description $ seealso $ telephoneNumber $ userPassword) X-ORIGIN ‘RFC 2252’) This schema entry states an object identifier, or OID, for the class (2.5.6.6), a name of the object class (person), a description of the class (standard person), then lists the required attributes (objectclass, sn, and cn) and the allowed attributes (description, seealso, telephoneNumber, and userPassword).

The proprietary attributes used by the schema hold specific data elements, such as a name or a fax number. The directory server represents data as attribute-data pairs, a descriptive attribute associated with a specific piece of information. For example, the directory may store a piece of data such as a person's name in a pair with the standard attribute, in this case CommonName (cn). Therefore, an entry for a person named Babs Jensen has the following attribute-data pair: cn: Babs Jensen. In fact, the entire entry is represented as a series of attribute-data pairs. The entire entry for Babs Jensen might appear as follows:

dn: uid=bjensen, ou=people, dc=siroe, dc=com

objectClass: top

objectClass: person

objectClass: organizationalPerson

objectClass: inetOrgPerson

cn: Babs Jensen

sn: Jensen

givenName: Babs

givenName: Barbara

mail: bjensen@siroe.com

uid: bjensen

Notice that the entry for Babs includes multiple values for some of the attributes. The attribute givenName appears twice, each time with a unique value.

In one ore more embodiments, each attribute definition of the schema of the directory server, includes the following information: a unique name, an object identifier (OID) for the attribute, a text description of the attribute, the OID of the attribute syntax, indications of whether the attribute is single-valued or multi-valued, whether the attribute is for the directory's own use, the origin of the attribute, any additional matching rules associated with the attribute, etc.

Proprietary object classes used in the schema group related information. Typically, an object class represents a real object, such as a person, a fax machine, etc. Before using an object class and attributes of the object class in the directory server, the object class is identified in the schema. The directory server recognizes a standard list of object classes by default. Each directory entry belongs to one or more object classes. Once an object class identified in your schema is placed on an entry, the directory server understands that the entry may have a certain set of attribute types and also has another, usually smaller, set of required attribute types that must be present in the entry. In other words, object class definitions describe allowed attribute types and required attribute types. Object class definitions may include the following information: a unique name, an object identifier (OID) that names the object, a set of mandatory attributes, a set of allowed attributes, etc.

As is the case for the directory server's entire schema, object classes are defined and stored directly in the directory server. Thus directory's schema may be queried and changed with standard LDAP operations The directory server schema may also be part of a replication system and may also be replicated across various servers.

In a replication system, the terms supplier and consumer are used to identify the source and destination of replication updates, respectively. A supplier server sends updates to another server; a consumer server accepts those changes. These roles are not mutually exclusive because a server that is a consumer may also be a supplier.

When part of a replication system, the directory server's schema is stored on a supplier server and then updated to a consumer server. Before pushing data to a consumer server, the supplier server checks whether its own version of the schema is in sync with the version of the schema held on the consumer server. The supplier accomplishes this by comparing a timestamp held on its own schema with a timestamp held in the consumer's schema. If the consumer's timestamp is older than the supplier's timestamp, the supplier server replicates its schema (and the associated timestamp) to the consumer. If the consumer's timestamp is the same as or newer than the supplier's schema, no schema update is performed.

A consumer may contain replicated data from two suppliers, each with different schema. Whichever supplier was updated last will “win” and its schema is propagated to the consumer. In other words, schema can be updated at any updateable replica. If two clients update schema on two different servers at the same time and replication between those servers does not occur between the two schema updates, the change that is assigned the smaller timestamp is lost. Still put another way, the granularity of the update resolution protocol is the entry, instead of the attribute value. Note that this granularity only applies for schema replication to simplify implementation.

Schema is typically maintained on a master supplier server in a replicated topology. When using custom schema files, the files are copied to all servers after making changes on the master supplier. After copying files, the server is restarted. Generally, a typical directory server requires that an administrator manually maintain schema on all replicas. If an update to the schema is required, the update is manually applied to all servers.

The present inventions provides a procedure whereby schema configuration may be replicated. When schema is updated at a replication supplier, the schema changes are propagated to each replication consumer at the beginning of the next replication session.

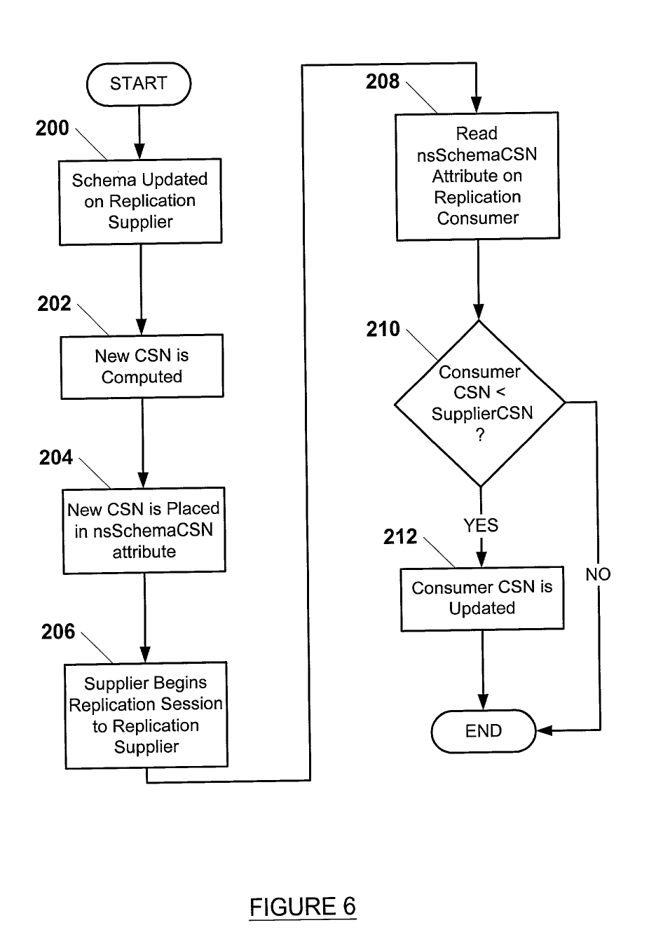

Schema may be updated on any updateable master. As shown in FIG. 6, each time schema is updated on a replication supplier (Step 200), a new change sequence number (CSN) is computed (Step 202) and placed in a nsSchemaCSN attribute (Step 204). When that supplier begins a replication session to a replication consumer (Step 206), the supplier first reads the nsSchemaCSN attribute on the replication consumer (Step 208). If the CSN is smaller than the CSN in the nsSchemaCSN attribute in the supplier's cn=schema entry (Step 210), then the schema on the consumer is updated (Step 212).

Schema updates are propagated by performing an LDAP update operation on the schema entry that replaces the entry's contents on the consumer with the entry's contents on the supplier. When replicas are arranged in a transitive topology, schema updates flow from the server to which they were originally submitted and then to each replication consumer. Each of the consumers that is also a supplier propagates the change, until all consumers are updated. Consumers that are not also suppliers do not accept schema updates from clients—only from other replication suppliers.

Advantages of the present invention may include one or more of the following. The schema replication saves time and expense by removing a once manual task from the administrator. The chance for errors in the schema replication are reduced by automating the process. Implementation of the schema replication described above may be done more easily that other schema replication methods, e.g., floating master, full multi-master, etc. Other advantages can be appreciated by those skilled in the art.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of schema replication in a directory server, comprising:
updating a schema at a replication supplier;
computing a change sequence number;
placing the change sequence number in an attribute on the replication supplier;
initiating a replication session to a replication consumer;
reading the change sequence number on the replication consumer;
updating the schema on the replication consumer if the change sequence number on the replication consumer is less than the change sequence number on the replication supplier; and
propagating a schema update from the replication supplier to each replication consumer.

2. The method of claim 1, further comprising:
replacing contents of a schema entry on each replication consumer with contents of a schema entry on the replication supplier.

3. The method of claim 3, wherein contents are replaced using an update operation on the schema entry.

4. The method of claim 1, further comprising:
maintaining the schema on a master supplier server.

5. The method of claim 4, further comprising:
copying the schema to a plurality of servers after updating the master supplier.

6. The method of claim 1, further comprising:
holding the change sequence number on the replication consumer in an attribute.

7. The method of claim 1, further comprising:
querying the schema with standard Lightweight Directory Access Protocol operations.

8. The method of claim 1, further comprising:
modifying the schema with standard Lightweight Directory Access Protocol operations.

9. The method of claim 1, wherein the schema is updateable on an updateable master.

10. A method of schema replication in a directory server, comprising:
updating a schema at a replication supplier;
computing a change sequence number;
placing the change sequence number in an attribute on the replication supplier;
initiating a replication session to a replication consumer;
reading the change sequence number on the replication consumer;
updating the schema on the replication consumer if the change sequence number on the replication consumer is less than the change sequence number on the replication supplier;
propagating a schema update from the replication supplier to each replication consumer;
replacing contents of a schema entry on each replication consumer with contents of a schema entry on the replication supplier;
maintaining the schema on a master supplier server;
copying the schema to a plurality of servers after updating the master supplier;
holding the change sequence number on the replication consumer in an attribute;
querying the schema with standard Lightweight Directory Access Protocol operations; and
modifying the schema with standard Lightweight Directory Access Protocol operations.

11. A method of defining a schema in a directory server, comprising
identifying an object class in the schema;
placing the object class on an entry;
storing a data element in an attribute in the directory server used by the schema;
extending the schema with a new object class and a new attribute;
describing a document with a private field comprising a description of the object class and the attribute; and
representing the data element as an attribute-data pair.

12. The method of claim 11, further comprising:
defining the object class in the directory server;
storing the object class in the directory server; and
maintaining integrity of the data element stored in the directory server is by imposing constraints on data values.

13. The method of claim 11, wherein the object class defines allowed attribute types and required attribute types.

14. The method of claim 11, wherein the attribute is multi-valued.

15. The method of claim 11, wherein the attribute is single-valued.

16. The method of claim 11, wherein the private field is a human-readable description.

17. The method of claim 11, wherein the attribute-data pair comprises a descriptive attribute associated with a data element.

18. The method of claim 11, wherein the entry in the directory server is customizable.

19. The method of claim 11, wherein the attribute available for the entry in the directory server is customizable.

20. A method of defining a schema in a directory server, comprising
identifying an object class in the schema;
placing the object class on an entry;
storing a data element in an attribute in the directory server used by the schema;
extending the schema with a new object class and a new attribute;
describing a document with a private field comprising a description of the object class and the attribute;
representing the data element as an attribute-data pair;
defining the object class in the directory server;
storing the object class in the directory server; and
maintaining integrity of the data element stored in the directory server by imposing constraints on data values.

21. A computer system for schema replication a directory server, comprising:
a processor;
a memory; and
software instructions stored in the memory for enabling the computer system under control of the processor, to perform:
updating a schema at a replication supplier;
computing a change sequence number;
placing the change sequence number in an attribute on the replication supplier;
initiating a replication session to a replication consumer;
reading the change sequence number on the replication consumer;
updating the schema on the replication consumer if the change sequence number on the replication consumer is less than the change sequence number on the replication supplier; and
propagating a schema update from the replication supplier to each replication consumer.

22. The computer system of claim 21, wherein the software instructions further comprise instructions to perform:
replacing the contents of a schema entry on each replication consumer with contents of a schema entry on the replication supplier using an update operation.

23. The computer system of claim 21, wherein the software instructions further comprise instructions to perform:
maintaining the schema on a master supplier server.

24. The computer system of claim 21, wherein the software instructions further comprise instructions to perform:
copying the schema to a plurality of servers after updating the master supplier.

25. The computer system of claim 21, wherein the software instructions further comprise instructions to perform:
holding the change sequence number on the replication consumer in the attribute.

26. The computer system of claim 21, wherein the software instructions further comprise instructions to perform:
querying the schema with standard Lightweight Directory Access Protocol operations.

27. The computer system of claim 21, wherein the software instructions further comprise instructions to perform:
modifying the schema with standard Lightweight Directory Access Protocol operations.

28. An apparatus for replicating a schema in a directory server, comprising:
means for updating a schema at a replication supplier;
means for computing a change sequence number;
means for placing the change sequence number in an attribute on the replication supplier;
means for initiating a replication session to a replication consumer;
means for reading the change sequence number on the replication consumer;
means for updating the schema on the replication consumer if the change sequence number on the replication consumer is less than the change sequence number on the replication supplier; and
means for propagating a schema update from the replication supplier to each replication consumer.

29. An apparatus for defining a schema in a directory server, comprising:
means for identifying an object class in the schema;
means for placing the object class on an entry;
means for storing a data element in an attribute in the directory server used by the schema;
means for extending the schema with a new object class and a new attribute;
means for describing a document with a private field comprising a description of the object class and the attribute; and
means for representing the data element as an attribute-data pair.

30. The apparatus of claim 29, further comprising:
means for defining the object class in the directory server;
means for storing the object class in the directory server; and
means for maintaining integrity of the data element stored in the directory server by imposing constraints on data values.
